(19) United States
(12) Patent Application Publication
(10) Pub. No.: US 2004/0212840 A1
(43) Pub. Date: Oct. 28, 2004

(54) Communication device and communication method

(75) Inventor: Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 10/806,243

(22) Filed: Mar. 23, 2004

(30) Foreign Application Priority Data
Apr. 22, 2003 (JP) 2003-117675

(51) Int. Cl. G06F 15/00; H04N 1/00

(52) U.S. Cl. 358/402; 358/1.14

(57) ABSTRACT

An instant message is generated in accordance with prescribed information displayed at a display unit. The instant message is transmitted to a prescribed client that can use the instant message. The transmitted instant message is displayed at a display unit of the client.

### BACKGROUND OF THE INVENTION

1. Field of the Invention

The present invention relates to technology for notifying information in a prescribed device, and more particularly to technology for notifying the status of a device to a terminal connected to a network.

2. Description of the Related Art

Information equipment, such as a printer, a scanner, a facsimile machine, and a Multi Functional Peripheral (MFP) is becoming widespread. The information equipment is connected to a network such as a Local Area Network (LAN) and shared by a plurality of terminals. Therefore, there are many cases where the information equipment is located remote from a user. For example, in the case of a facsimile machine, to confirm transmission or to confirm consumables or the like, it is necessary for a user to go to the facsimile machine to confirm by oneself. To improve such a circumstance, there is an image scanning device which notifies a manager or the like of the device with the status of the consumables or the like by using electronic mail. Such a notification from the information equipment will be referred to as “status notification”.

In the case of such a device having a notification unit, the status notification is carried out by electronicmail, in other words, by Simple Mail Transfer Protocol (SMTP), even for general contents such as a transmission result and out of paper. After accumulating in a mail server, the electronic mail is read into the terminal from the mail server by Post Office Protocol (POP) or the like. Therefore, for example, when there is a larger amount of electronic mail from a facsimile machine, the storage capacity of the mail server is cluttered with the electronic mail and the load on the mail server becomes heavy. In addition, since the electronic mail accumulates in the terminal, the storage capacity of the terminal is also cluttered with the electronic mail. To refer to the electronic mail accumulated in the mail server, it is necessary for the terminal to request the mail server to read in the electronic mail. Therefore, there is a time lag between when the facsimile machine transmits the electronic mail and when a user actually sees the electronic mail.

### SUMMARY OF THE INVENTION

An advantage of the present invention is to provide technology which obtains the status of the information equipment from a remote location, constitutes a display unit of the remote location, reduces the load on the storage capacity of a mail server or a terminal generated by status notifications from the information equipment, executes the status notification instantly, and executes the status notification efficiently.

According to an aspect of the present invention, an instant message corresponding to prescribed information displayed at a display unit of a communication device is generated, and the instant message is transmitted to a client that can use instant message service. Accordingly, a user can refer to the prescribed information displayed at the display unit of the communication device via the client on a network. Moreover, the prescribed information can be notified promptly to a user logged in at a server that offers the instant message service.

“The client that can use the instant message service” is the client logged in at the server that offers the instant message service. The “login” is a series of procedures for enabling the use of the instant message service offered by the server and the client. For example, the “login” is an authentication procedure for accessing the server. The “logged in” status is a status in which the login has been completed and the instant message service can be used. The “prescribed information” is various pieces of information displayed at the display unit of the device, such as communication status of the device, transmission or reception status of facsimile data or the like, status relating to consumables, such as “out of paper”, “run out of toner” or the like, or status relating to an abnormality of the device, such as paper jam, breakdown of the device or communication failure. The information can be a character string, an image, a voice or the like that shows the prescribed status in a straightforward manner.

An instant message generating unit generates an instant message by simplifying the prescribed information, and can transmit the instant message to the client. Accordingly, the device can transmit to the client the prescribed information in which unnecessary information is excluded. “To simply the prescribed information” is to change the character string, the image or the voice included in the prescribed information into a format that can be transmitted by using the instant message. For example, a part of the character string can be abbreviated or replaced with another character string, the image can be abbreviated or replaced with a character string, or the voice can be abbreviated or replaced with a character string or an image. Moreover, the device generates detailed information of the prescribed information as an instant message and can transmit the instant message to the client. Accordingly, the device can transmit the detailed information relating to the prescribed information to the client.

When the prescribed information notified by the display unit can be transmitted to the client, the display unit can proceed to an energy saving mode. The “energy saving mode” status reduces energy consumption by turning off a display, decreasing a contrast or turning off a backlight.

Any conversion of the combination of the above constituent elements or the expression of the present invention between a method, a device, a system, a recording medium, a computer program or the like is also effective as an embodiment of the present invention.

### BRIEF DESCRIPTION OF THE DRAWINGS

FIG. 1 shows a configuration of a communication system according to an embodiment of the present invention.

FIG. 2 shows a configuration of a facsimile communication device.

FIG. 3 shows an example of data structure in a user information database.

FIG. 4 shows an example of data structure in a message database.

### DETAILED DESCRIPTION OF THE PREFERRED EMBODIMENTS

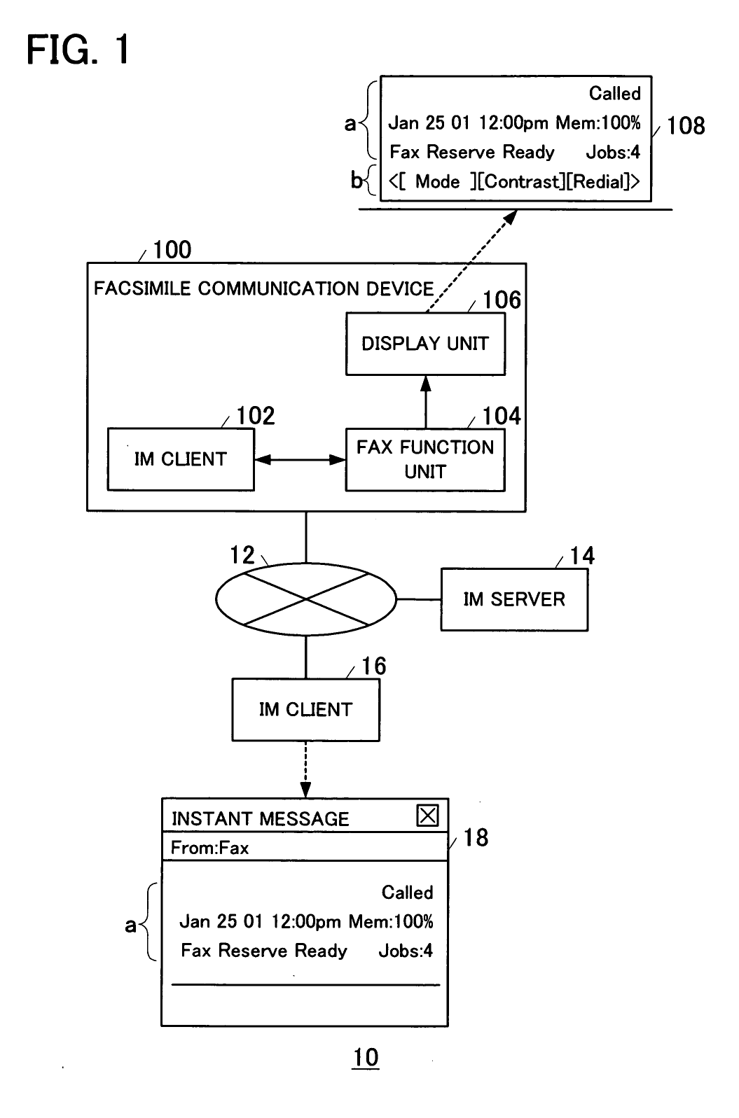

FIG. 1 shows a configuration of a communication system 10 according to an embodiment of the present invention. An instant message server 14 (hereinafter referred to as the “IM server 14”) is a server for offering instant message service (hereinafter referred to as the “IM service”). For example, the IM service includes service for offering information indicating whether or not a user of the IM service (hereinafter referred to as the “IM user”) can transmit and receive a message (hereinafter referred to as the “presence service”), and service for communicating a message between the IM users (hereinafter referred to as the “message service”).

The “instant message” can be a generic name of the presence service and the message service, or it can indicate one of the presence service or the message service. In short, the instant message is the information transmitted in the IM service. The instant message will be referred to simply as the “message”. The IM user can use the IM service by using an instant message client (hereinafter referred to as the “IM client”) . In the following, the status when the IM user is logged in at the IM server 14, in other words, the status when the message can be transmitted and received, will be referred to as “active”.

In the IM service, a message is received when the IM user is active. Therefore, the IM server 14 is not provided with a mechanism for temporarily storing the message explicitly as in a mail server used in SMTP or POP. Thus, the message is immediately notified to the IM client of the IM user, which is a destination, and a push-typed notification can be carried out. The IM server 14 can be an existing server that offers the IM service, or a new IM server 14 can be provided. Moreover, a facsimile communication device 100 to be described later can be provided with an IM server.

The facsimile communication device 100 includes an IM client 102 for using the IM service, a facsimile (FAX) function unit 104 for implementing a facsimile function, and a display unit 106 for displaying various pieces of information as a user interface. For example, the IM client 102 can be supporting only one IM service, or can be supporting a plurality of IM services. The FAX function unit 104 includes a function for communicating facsimile data by a communication method such as Group 3 (G3) or Group 4 (G4) and a function for communicating electronic mail including facsimile data via a network 12. The “facsimile data” is a series of data communicated in accordance with a facsimile protocol, and can be image data communicated via a public network or image data transmitted using electronic mail.

An instant message client 16 (hereinafter referred to as the “IM client 16”) is an IM client for the IM user to use the IM service. The IM client 16 establishes a connection with the IM server 14 via the network 12. The IM client 16 is formed on a terminal by executing a prescribed program by a computer or the like. By logging into the IM server 14, the IM client 102 and the IM client 16 become capable of using the IM service, in other words, become active.

A display screen 108 is an example of a display screen displayed at the display unit 106. The prescribed information displayed at the display unit 106 will be referred to as the “device screen information”. A display screen 18 is an example of an instant message screen displayed at the IM client 16. For example, the display screen 18 displays information that is the same or a simplification of the device screen information or it displays detailed information. The information displayed at the display screen 18 will be referred to as the “remote screen information”. In FIG. 1, the remote screen information that is a simplification of the device screen information that is displayed at the display screen 18.

The display screen 108 displays first information (a), which is information indicating the status of the device, and second information (b), which is information indicating a function of function keys of the device. The display screen 18 displays only the first information (a). As described above, by displaying the information, which is displayed at the display unit 106, at the IM client 16 provided over the network 12 by using the IM service, it becomes unnecessary for the user to go to the facsimile communication device 100 to confirm the display unit 106.

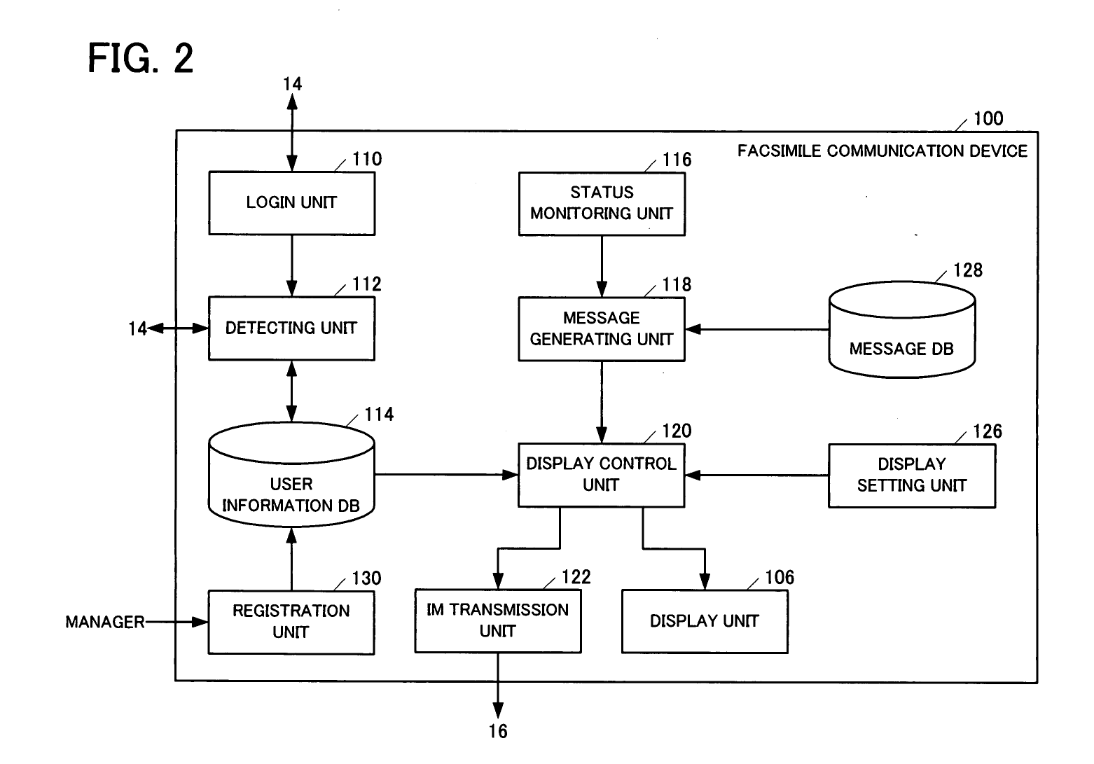

FIG. 2 is a block diagram showing an inner configuration of the facsimile communication device 100 of FIG. 1. In terms of hardware components, each of the constituent elements of the facsimile communication device 100 is mainly realized by a Central Processing Unit (CPU) of a computer, a memory, a program loaded in the memory for realizing the constituent elements of FIG. 2, a storage unit, such as a hard disk that stores the program, an interface for establishing a connection with a network, and a modem for facsimile communication, or the like. It is to be understood by those skilled in the art that there are various variations and modifications to the method and the device. Each of the drawings to be described below shows blocks by a unit of function and not a configuration by a unit of hardware. In FIG. 2, a login unit 110, a detecting unit 112 and an IM transmission unit 122 mainly correspond to the IM client 102 of FIG. 1, and other configurations correspond to the FAX function unit 104 of FIG. 1.

The login unit 110 establishes a connection with the IM server 14 and executes the login process of the IM service so that the facsimile communication device 100 becomes active. For the login process, the login unit 110 holds identification information for using the IM service (hereinafter referred to as the “login ID”) and a password or the like. The information necessary for the login will be referred to as the “login information”. The login unit 110 can hold the login information in advance or can accept a setting from a manager or the like of the facsimile communication device 100. In the case of supporting a plurality of IM services, the login unit 110 holds the login information for each of the IM services.

A user information database 114 holds information of the user of the device and information indicating whether or not the user of the device has logged in at the IM server 14, in other words, whether or not the user of the device is active. After the login has been completed by the login unit 110, the detecting unit 112 queries the IM server 14 as to whether or not the user of the device held in the user information database 114 is active.

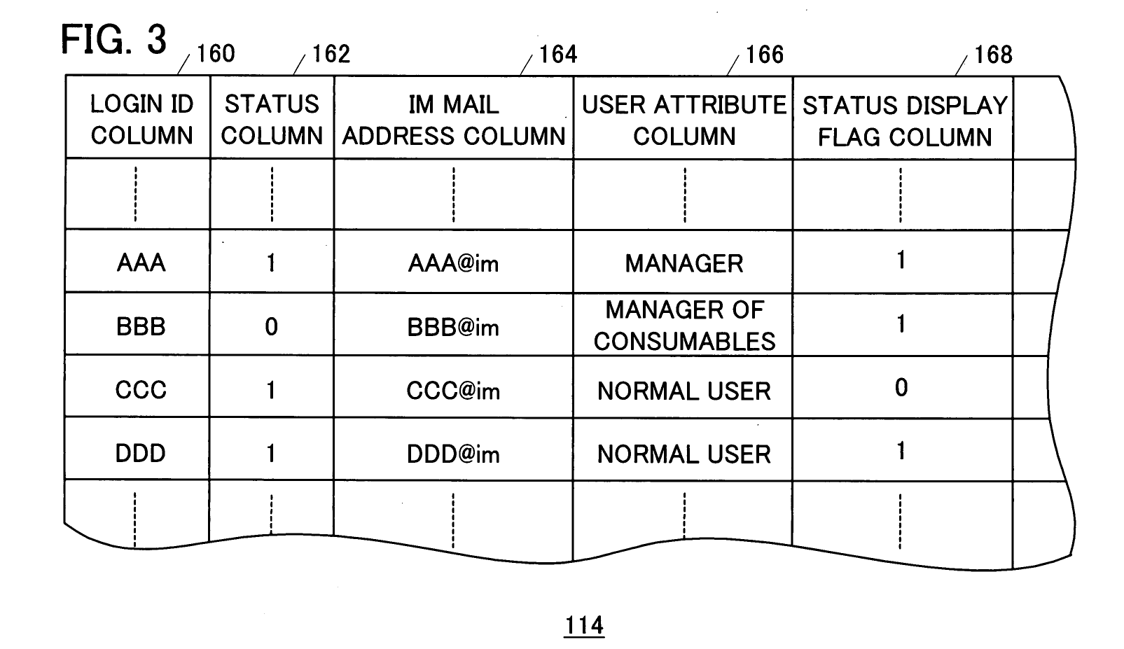

FIG. 3 shows an example of a data structure in the user information database 114 of FIG. 2. A login ID column 160 holds information regarding the user of the device that can specify the IM user in the IM service, such as a login ID (hereinafter referred to as the “IM identification information”). The detecting unit 112 of FIG. 2 uses the presence service to detect the login status of the IM user specified by the IM identification information, in other words, whether or not the IM user is active. A status column 162 holds for each IM user, the login status detected by the detecting unit 112. In FIG. 3, “1” shows active status, and “0” shows inactive status, in other words, shows that the IM user is not logged in.

An IM address column 164 holds information for designating a destination of a message in the IM service (hereinafter referred to as the “IM address”) . For example, when the IM address corresponds with the IM identification information, the IM identification information can be held in the IM address column 164. A user attribute column 166 holds the attribute information of the user of the device. Although details will be described later, the facsimile communication device 100 presents the remote display screen according to the attribute for each user of the device. In FIG. 3, a manager, a manager of consumables, and a normal user or the like are set as the attribute. For example, the remote display screen relating to the communication status is mainly presented to the normal user, and the remote display screen relating to the consumables is mainly presented to the manager of the consumables.

A status display flag column 168 holds information that designates whether or not to present the remote display screen. In FIG. 3, “1” indicates to present the remote display screen and “0” indicates not to present the remote display screen. For example, when the user of the device of the login ID “AAA” is active, the facsimile communication device 100 presents the remote display screen. However, even if the user of the device of the login ID “CCC” is active, the remote display screen is not presented.

Returning to FIG. 2, a registration unit 130 receives from the manager, the login ID of the user of the device, the IM address, the attribute and a presence or an absence of the status display, or the like. Then, the registration unit 130 stores the information in the user information database 114. A status monitoring unit 116 monitors various statuses in the facsimile communication device 100, for example, “reception”, “transmission”, “transmission error”, “run out of toner”, “out of paper” and “paper jam”. The status monitoring unit 116 outputs identification information that specifies the status (hereinafter referred to as the “status code”) to a message generating unit 118. The message generating unit 118 refers to a message database 128 based on the status code, and generates the device screen information and the remote screen information.

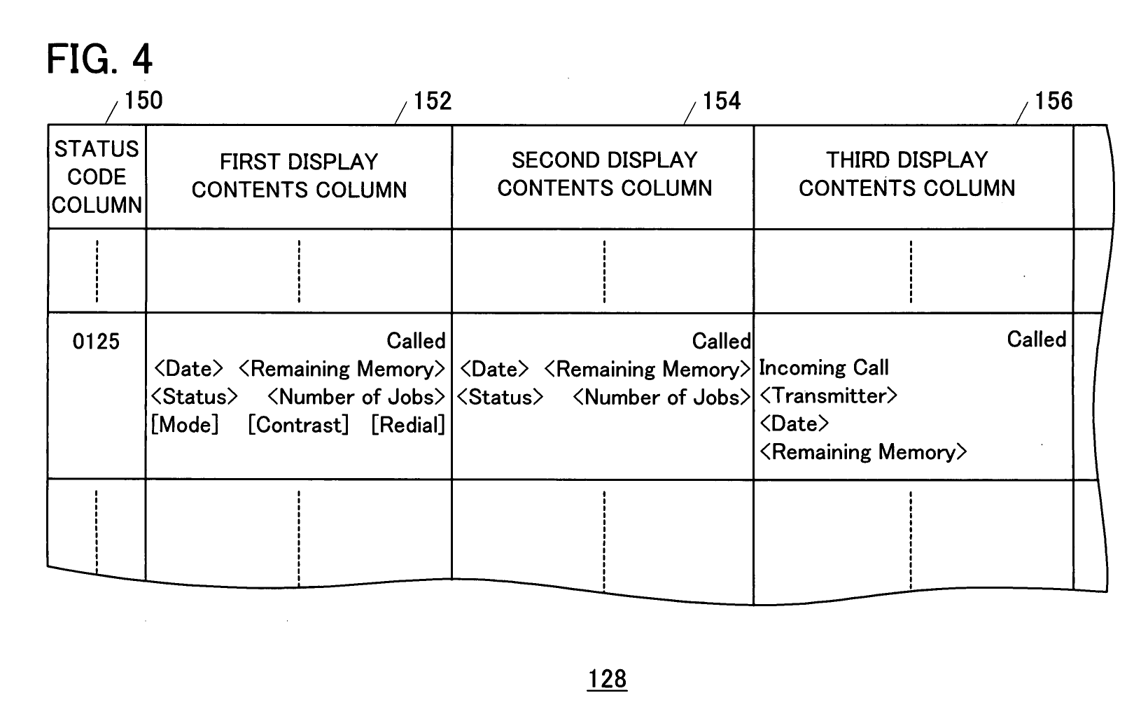

FIG. 4 shows an example of a data structure in the message database 128. A status code column 150 holds the status code. For example, the message generating unit 118 of FIG. 2 selects from the message database 128, a record that corresponds with the status code supplied from the status monitoring unit 116. A first display contents column 152 holds contents to be displayed at the display unit 106 of FIG. 1, in other words, the device screen information. A second display contents column 154 holds contents to be displayed at the IM client 16 of FIG. 1, in other words, the remote screen information that is a simplification of the device screen information. A third display contents column 156 holds the remote screen information that includes detailed information. For example, when the attribute of the user of the device is the manager, the message generating unit 118 generates the remote screen information by using the information held in the third display contents column 156. When the attribute of the user of the device is the normal user, the message generating unit 118 can generate the remote screen information by using the information held in the second display contents column 154.

Returning to FIG. 2, the message generating unit 118 outputs the generated device screen information and the remote screen information to a display control unit 120. The display control unit 120 refers to the user information database 114 and instructs the IM transmission unit 122 to transmit the remote screen information to the IM address of the user of the device designated to display the status. The IM transmission unit 122 transmits the remote screen information to the designated IM address by using the IM service. The display control unit 120 supplies the device screen information to the display unit 106. The display unit 106 displays the device screen information supplied.

A display setting unit 126 sets whether to display the device information at the display unit 106 or the IM client 16. When the device information is set to be displayed at the display unit 106, the display control unit 120 supplies the device screen information to the display unit 106. At this time, the display control unit 120 is not required to supply the remote screen information to the IM transmission unit 122. When the device information is set to be displayed at the IM client 16, the display control unit 120 supplies the remote screen information to the IM transmission unit 122. At this time, the display control unit 120 is not required to supply the device screen information to the display unit 106, or can supply information for displaying a message such as “operating under IM mode”. The display control unit 120 can turn off the display at the display unit 106, reduce the contrast or turn off the backlight. Accordingly, the display control unit 120 can switch the display unit 106 to an energy saving mode and reduce the energy consumption at the display unit 106. The display control unit 120 can switch the display unit 106 to an energy saving mode when the IM client 16 is logged on and the remote screen information can be transmitted.

The present invention has been described with reference to an embodiment. The above-described embodiment is an example, and it is to be understood by those skilled in art that there are variations in the combinations of each of the constituent elements and each of the processes and such variations also fall within the scope of the present invention. As a variation, for example, the above-described functions can be provided in a MFP, a scanner, a copy machine, a printer, a router, a modem, and consumer electronics that can establish a connection with a network.

As another variation, for example, the login ID or the IM address of the IM service to be used by a service person of a service center can be stored in the user information database 114 of FIG. 3, and the status of the facsimile communication device 100 can be monitored from a remote location. Accordingly, since the status of the facsimile communication device 100 can be obtained from the remote location, even when the device breaks down, the service person can promptly understand the situation of the breakdown and can take appropriate measures.

What is claimed is:

1. A communication device comprising:
a display unit which displays prescribed information;
an instant message generating unit which generates an instant message from the prescribed information; and
a transmission unit which transmits the generated instant message to a client that can use instant message service.

2. The communication device according to claim 1, wherein the instant message generating unit simplifies the prescribed information to generate the instant message.

3. The communication device according to claim 1, wherein the instant message generating unit generates detailed information regarding the prescribed information as the instant message.

4. The communication device according to claim 1, wherein when the instant message corresponding to the prescribed information displayed at the display unit can be transmitted to the client, the display unit proceeds to an energy saving mode.

5. The communication device according to claim 1, further comprising:
a destination information storage unit which stores destination information of the client that can use the instant message service;
wherein the instant message is transmitted to a destination stored in the destination information storage unit.

6. The communication device according to claim 5, further comprising:
an attribute information storage unit which stores attribute information of the destination;
wherein the instant message generating unit generates an instant message by referring to the attribute information stored in the attribute information storage unit.

7. A communication device comprising:
means for displaying prescribed information;
means for generating an instant message from the prescribed information; and
means for transmitting the generated instant message to a client that can use instant message service.

8. The communication device according to claim 7, wherein the means for generating the instant message simplifies the prescribed information to generate the instant message.

9. The communication device according to claim 7, wherein the means for generating the instant message generates detailed information regarding the prescribed information as the instant message.

10. The communication device according to claim 7, wherein when the instant message corresponding to the prescribed information displayed at the means for displaying can be transmitted to the client, the means for displaying proceeds to an energy saving mode.

11. The communication device according to claim 7, further comprising:
means for storing a destination of the client;
wherein the means for transmitting the instant message transmits the instant message to the destination stored in the means for storing the destination.

12. The communication device according to claim 11, further comprising:
means for storing attribute information of the destination;
wherein the means for generating the instant message generates the instant message by referring to the attribute information stored in the means for storing the attribute information.

13. A communication method comprising:
collecting prescribed information in a device;
displaying the prescribed information at a display unit of the device;
generating an instant message from the prescribed information; and
transmitting the generated instant message to a client that can use the instant message.

14. The communication method according to claim 13, further comprising:
obtaining attribute information regarding the client that can use the instant message; and
generating the instant message from the prescribed information in accordance with the obtained attribute information.

15. The communication method according to claim 13, comprising:
generating the instant message by simplifying the prescribed information in accordance with the attribute information.

16. The communication method according to claim 13, comprising:
generating the instant message including detailed information of the prescribed information in accordance with the attribute information.

17. The communication method according to claim 13, comprising:
transmitting a plurality of instant messages according to the attribute information for each client.

18. The communication method according to claim 13, further comprising:
switching the display unit to an energy saving mode after transmitting the instant message.

19. The communication method according to claim 13, further comprising:
determining whether there is a client that can use the instant message; and
displaying the instant message at the display unit when there is the client that can use the instant message.

20. The communication method according to claim 13, further comprising:
transmitting the instant message to an instant message server; and
transmitting the instant message immediately from the instant message server to the client.
